(19) United States
(12) Patent Application Publication
(10) Pub. No.: US 2017/0323418 A1
(43) Pub. Date: Nov. 9, 2017

(54) VIRTUALIZED GPU IN A VIRTUAL MACHINE ENVIRONMENT

(71) Applicant: MICROSOFT TECHNOLOGY LICENSING, LLC, Redmond, WA (US)

(72) Inventors: Asael DROR, San Francisco, CA (US); Hao ZHANG, Sunnyvale, CA (US); B. Anil KUMAR, Saratoga, CA (US); Stuart Ray PATRICK, Bellevue, WA (US); Neal D. MARGULIS, Woodside, CA (US); Lin TAN, Cupertino, CA (US); Pandele STANESCU, Santa Clara, CA (US); Martin AMON, Palo Alto, CA (US); Miriam Barbara SEDMAN, Palo Alto, CA (US)

(21) Appl. No.: 15/614,466

(22) Filed: Jun. 5, 2017

Related U.S. Application Data
(63) Continuation of application No. 12/631,662, filed on Dec. 4, 2009, now abandoned.
(60) Provisional application No. 61/258,055, filed on Nov. 4, 2009.

(51) Int. Cl. G06T 1/20; G06F 9/455

(52) U.S. Cl. CPC G06T 1/20; G06F 9/45558; G06F 2009/45579

(57) ABSTRACT

Techniques are described for providing graphics functionality. In a first partition, a software interface comprising graphics capabilities that are abstracted from capabilities of the graphics accelerator device is loaded. In a second partition loading, a graphics capturing and rendering process is loaded. The software interface on the first partition receives a request to render graphics. The request is based on the abstracted graphics capabilities. The graphics capturing and rendering process renders the requested graphics on the second partition. The abstracted graphics capabilities are effectuated in accordance with the capabilities of the graphics accelerator device. The capturing process executing on the second partition provides the rendered graphics to the first partition.

### CROSS-REFERENCE

This application is a continuation of U.S. patent application Ser. No. 12/631,662 filed Dec. 4, 2009, which claims the benefit of U.S. Provisional Patent Application No. 61/258,055, filed Nov. 4, 2009, the content of each are hereby incorporated by reference in their entirety.

### BACKGROUND

Remote computing systems can enable users to remotely access hosted resources. Servers on the remote computing systems can execute programs and transmit signals indicative of a user interface to clients that can connect by sending signals over a network conforming to a communication protocol such as the TCP/IP protocol. Each connecting client may be provided a remote presentation session, i.e., an execution environment that includes a set of resources. Each client can transmit signals indicative of user input to the server and the server can apply the user input to the appropriate session. The clients may use remote presentation protocols such as the Remote Desktop Protocol (RDP) to connect to a server resource.

The use of virtualization to abstract underlying hardware can be used to share such hardware resources and manage their use by a plurality of remote users. Virtual machines have become increasingly popular as a technology for multiplexing both desktop and server computers. Additionally, virtual desktop infrastructure (VDI) initiatives have led many enterprises to simplify their desktop management by delivering virtual machines to their users. The virtualization of CPUs can now be accomplished efficiently and with low overhead. However, current virtualization techniques do not allow for the efficient virtualization of accelerators such as Graphics Processing Units (GPUs). In many existing implementations, only 2D graphics rendering may be supported via virtualization of the CPU. In such implementations, the user's multimedia experience and audio/video synchronization may be limited. The virtualization of GPUs present significant challenges due to their proprietary programming models, complexity, and rapid technology changes. However, GPUs now provide significant computational performance as compared to CPUs. Furthermore, GPU applications have extended beyond video and video gaming into the display functions of operating systems and non-graphical high-performance applications. The rise in applications that are now using GPU acceleration makes it increasingly desirable to virtualize graphics hardware in virtualized environments.

Thus, other techniques are needed in the art to solve the above described problems.

### SUMMARY

Methods and systems are disclosed for virtualizing a graphics accelerator such as a GPU. In one embodiment, a GPU is virtualized and may be paravirtualized. Rather than modeling a complete hardware GPU, paravirtualization may provide for an abstracted software-only GPU that presents a software interface different from that of the underlying hardware. By providing a paravirtualized GPU, a virtual machine may enable a rich user experience with, for example, accelerated 3D rendering and multimedia, without the need for the virtual machine to be associated with a particular GPU product.

In various embodiments, a virtualized GPU is disclosed. The virtualized GPU may provide 3D graphics capability for virtual machines spawned by a hypervisor or virtual machine monitor. Each virtual machine may load a virtual GPU driver. A virtualization system may be populated with one or more GPU accelerators that are accessible from the parent partition of the virtualization system. The physical GPUs on the parent partition may thus be shared by the different virtual machines to perform rendering operations. The virtual GPU virtualizes the physical GPU and may provide accelerated rendering capability for the virtual machines. The virtual GPU driver may remote corresponding commands and data to the parent partition for rendering. A rendering process, which in one embodiment may be part of a subsystem that renders, captures and compresses graphics data, may perform the corresponding rendering on the physical GPU. For each virtual machine, there may be a corresponding render/capture/compress component on the host or parent partition. Upon request by a graphics source subsystem running on the virtual machine, the render/capture/compress component may return compressed or uncompressed screen updates as appropriate, based on the changed tile size and the content. In one embodiment, the virtual GPU subsystem may comprise the virtual GPU driver including user mode and kernel mode components that execute on the virtual machines, and a rendering component of the render/capture/compress process that executes on the parent partition.

In addition to the foregoing, other aspects are described in the claims, drawings, and text forming a part of the present disclosure. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for altering a view perspective within a virtual environment in accordance with this specification are further described with reference to the accompanying drawings in which:

FIGS. 1a and 1b depict an example computer system wherein aspects of the present disclosure can be implemented.

FIG. 2 depicts an operational environment for practicing aspects of the present disclosure.

FIG. 3 depicts an operational environment for practicing aspects of the present disclosure.

FIG. 4 illustrates a computer system including circuitry for effectuating remote desktop services.

FIG. 5 illustrates a computer system including circuitry for effectuating remote services.

FIG. 6 illustrates an example architecture incorporating aspects of the methods disclosed herein.

FIG. 7 illustrates example abstraction layers of a virtualized GPU.

FIG. 8 illustrates an example architecture incorporating aspects of the methods disclosed herein.

FIG. 9 illustrates an example architecture incorporating aspects of the methods disclosed herein.

FIG. 10 illustrates an example of an operational procedure for providing virtualized graphics accelerator functionality to a virtual machine.

FIG. 11 illustrates an example system for providing virtualized graphics accelerator functionality to a virtual machine.

FIG. 12 illustrates a computer readable medium bearing computer executable instructions discussed with respect to FIGS. 1-11.

### DETAILED DESCRIPTION

### Computing Environments

Certain specific details are set forth in the following description and figures to provide a thorough understanding of various embodiments of the disclosure. Certain well-known details often associated with computing and software technology are not set forth in the following disclosure to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure.

It should be understood that the various techniques described herein may be implemented in connection with hardware or software or, where appropriate, with a combination of both. Thus, the methods and apparatus of the disclosure, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

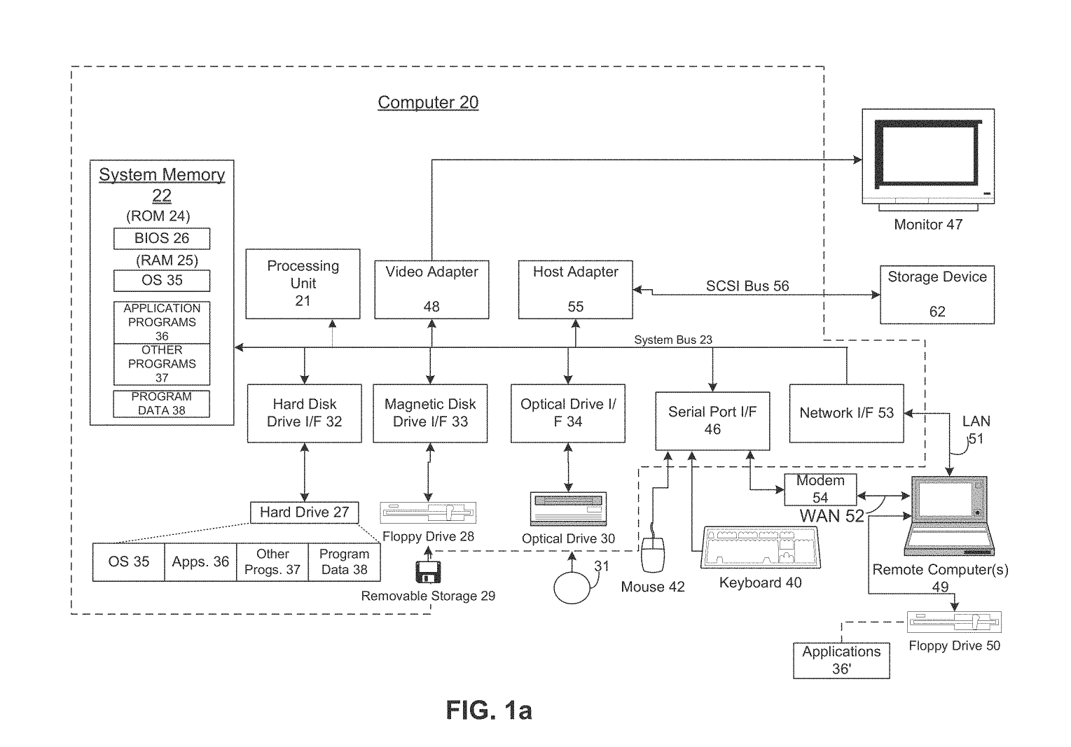

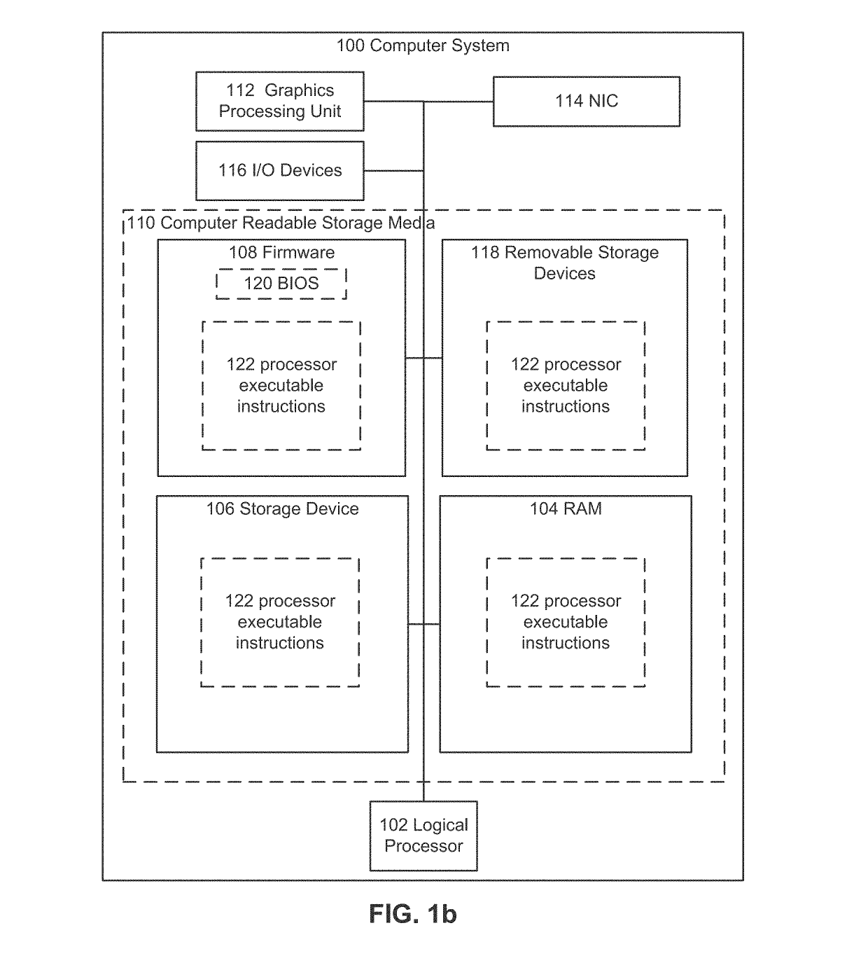

Embodiments may execute on one or more computers. FIGS. 1a and 1b and the following discussion are intended to provide a brief general description of a suitable computing environment in which the disclosure may be implemented. One skilled in the art can appreciate that computer systems 200, 300 can have some or all of the components described with respect to computer 100 of FIGS. 1a and 1b.

The term circuitry used throughout the disclosure can include hardware components such as hardware interrupt controllers, hard drives, network adaptors, graphics processors, hardware based video/audio codecs, and the firmware/software used to operate such hardware. The term circuitry can also include microprocessors configured to perform function(s) by firmware or by switches set in a certain way or one or more logical processors, e.g., one or more cores of a multi-core general processing unit. The logical processor(s) in this example can be configured by software instructions embodying logic operable to perform function(s) that are loaded from memory, e.g., RAM, ROM, firmware, and/or virtual memory. In example embodiments where circuitry includes a combination of hardware and software an implementer may write source code embodying logic that is subsequently compiled into machine readable code that can be executed by a logical processor. Since one skilled in the art can appreciate that the state of the art has evolved to a point where there is little difference between hardware, software, or a combination of hardware/software, the selection of hardware versus software to effectuate functions is merely a design choice. Thus, since one of skill in the art can appreciate that a software process can be transformed into an equivalent hardware structure, and a hardware structure can itself be transformed into an equivalent software process, the selection of a hardware implementation versus a software implementation is trivial and left to an implementer.

FIG. 1a depicts an example of a computing system which is configured to with aspects of the disclosure. The computing system can include a computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. In some example embodiments, computer executable instructions embodying aspects of the disclosure may be stored in ROM 24, hard disk (not shown), RAM 25, removable magnetic disk 29, optical disk 31, and/or a cache of processing unit 21. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, a virtual machine, and typically can include many or all of the elements described above relative to the computer 20, although only a memory storage device 50 has been illustrated in FIG. 1a. The logical connections depicted in FIG. 1a can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are examples and other means of establishing a communications link between the computers may be used. Moreover, while it is envisioned that numerous embodiments of the disclosure are particularly well-suited for computer systems, nothing in this document is intended to limit the disclosure to such embodiments.

Referring now to FIG. 1b, another embodiment of an exemplary computing system 100 is depicted. Computer system 100 can include a logical processor 102, e.g., an execution core. While one logical processor 102 is illustrated, in other embodiments computer system 100 may have multiple logical processors, e.g., multiple execution cores per processor substrate and/or multiple processor substrates that could each have multiple execution cores. As shown by the figure, various computer readable storage media 110 can be interconnected by one or more system busses which couples various system components to the logical processor 102. The system buses may be any of several types of bus structures including a memory bus or memory controller, a peripheral bus, and a local bus using any of a variety of bus architectures. In example embodiments the computer readable storage media 110 can include for example, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media can be used such as magnetic cassettes, flash memory cards, digital video disks, Bernoulli cartridges.

The computer readable storage media provide non volatile storage of processor executable instructions 122, data structures, program modules and other data for the computer 100. A basic input/output system (BIOS) 120, containing the basic routines that help to transfer information between elements within the computer system 100, such as during start up, can be stored in firmware 108. A number of programs may be stored on firmware 108, storage device 106, RAM 104, and/or removable storage devices 118, and executed by logical processor 102 including an operating system and/or application programs.

Commands and information may be received by computer 100 through input devices 116 which can include, but are not limited to, a keyboard and pointing device. Other input devices may include a microphone, joystick, game pad, scanner or the like. These and other input devices are often connected to the logical processor 102 through a serial port interface that is coupled to the system bus, but may be connected by other interfaces, such as a parallel port, game port or universal serial bus (USB). A display or other type of display device can also be connected to the system bus via an interface, such as a video adapter which can be part of, or connected to, a graphics processor 112. In addition to the display, computers typically include other peripheral output devices (not shown), such as speakers and printers. The exemplary system of FIG. 1 can also include a host adapter, Small Computer System Interface (SCSI) bus, and an external storage device connected to the SCSI bus.

Computer system 100 may operate in a networked environment using logical connections to one or more remote computers, such as a remote computer. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through a network interface card 114. The NIC 114, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

A remote desktop system is a computer system that maintains applications that can be remotely executed by client computer systems. Input is entered at a client computer system and transferred over a network (e.g., using protocols based on the International Telecommunications Union (ITU) T.120 family of protocols such as Remote Desktop Protocol (RDP)) to an application on a terminal server. The application processes the input as if the input were entered at the terminal server. The application generates output in response to the received input and the output is transferred over the network to the client computer system. The client computer system presents the output data. Thus, input is received and output presented at the client computer system, while processing actually occurs at the terminal server. A session can include a shell and a user interface such as a desktop, the subsystems that track mouse movement within the desktop, the subsystems that translate a mouse click on an icon into commands that effectuate an instance of a program, etc. In another example embodiment the session can include an application. In this example while an application is rendered, a desktop environment may still be generated and hidden from the user. It should be understood that the foregoing discussion is exemplary and that the presently disclosed subject matter may be implemented in various client/server environments and not limited to a particular terminal services product.

In most, if not all remote desktop environments, input data (entered at a client computer system) typically includes mouse and keyboard data representing commands to an application and output data (generated by an application at the terminal server) typically includes video data for display on a video output device. Many remote desktop environments also include functionality that can be extended to transfer other types of data.

Communications channels can be used to extend the RDP protocol by allowing plug-ins to transfer data over an RDP connection. Many such extensions exist. Features such as printer redirection, clipboard redirection, port redirection, etc., use communications channel technology. Thus, in addition to input and output data, there may be many communications channels that need to transfer data. Accordingly, there may be occasional requests to transfer output data and one or more channel requests to transfer other data contending for available network bandwidth.

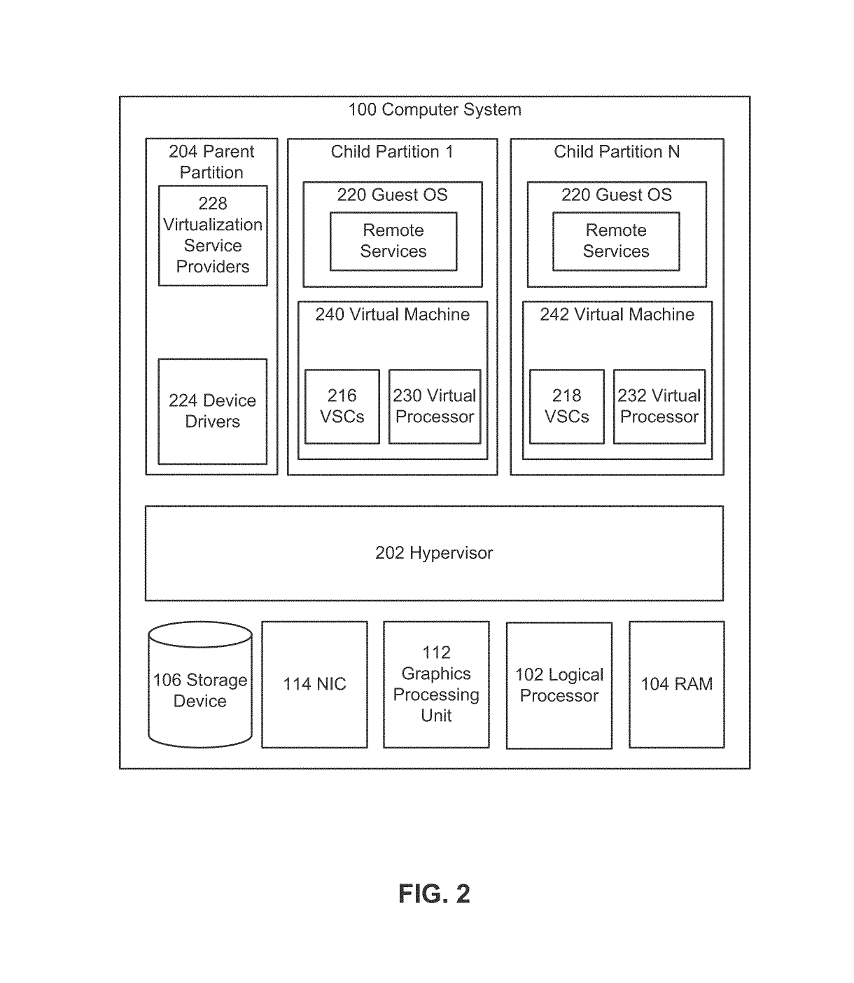

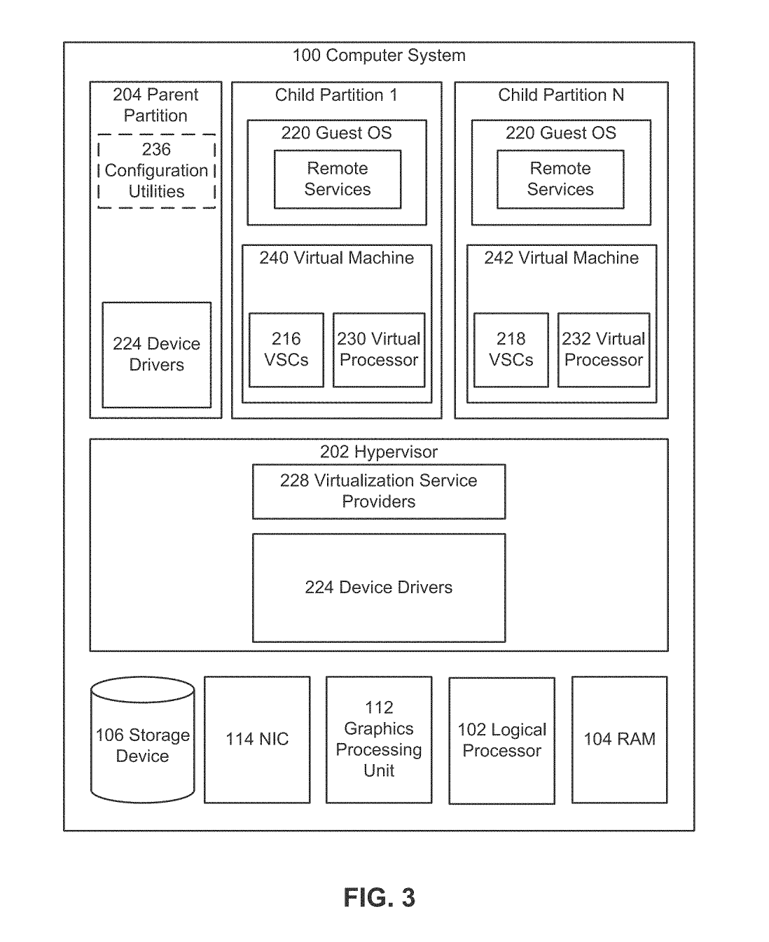

Referring now to FIGS. 2 and 3, depicted are high level block diagrams of computer systems configured to effectuate virtual machines. As shown in the figures, computer system 100 can include elements described in FIGS. 1a and 1b and components operable to effectuate virtual machines. One such component is a hypervisor 202 that may also be referred to in the art as a virtual machine monitor. The hypervisor 202 in the depicted embodiment can be configured to control and arbitrate access to the hardware of computer system 100. Broadly stated, the hypervisor 202 can generate execution environments called partitions such as child partition 1 through child partition N (where N is an integer greater than or equal to 1). In embodiments a child partition can be considered the basic unit of isolation supported by the hypervisor 202, that is, each child partition can be mapped to a set of hardware resources, e.g., memory, devices, logical processor cycles, etc., that is under control of the hypervisor 202 and/or the parent partition and hypervisor 202 can isolate one partition from accessing another partition's resources. In embodiments the hypervisor 202 can be a stand-alone software product, a part of an operating system, embedded within firmware of the motherboard, specialized integrated circuits, or a combination thereof.

In the above example, computer system 100 includes a parent partition 204 that can also be thought of as domain 0 in the open source community. Parent partition 204 can be configured to provide resources to guest operating systems executing in child partitions 1-N by using virtualization service providers 228 (VSPs) that are also known as back-end drivers in the open source community. In this example architecture the parent partition 204 can gate access to the underlying hardware. The VSPs 228 can be used to multiplex the interfaces to the hardware resources by way of virtualization service clients (VSCs) that are also known as front-end drivers in the open source community. Each child partition can include one or more virtual processors such as virtual processors 230 through 232 that guest operating systems 220 through 222 can manage and schedule threads to execute thereon. Generally, the virtual processors 230 through 232 are executable instructions and associated state information that provide a representation of a physical processor with a specific architecture. For example, one virtual machine may have a virtual processor having characteristics of an Intel x86 processor, whereas another virtual processor may have the characteristics of a PowerPC processor. The virtual processors in this example can be mapped to logical processors of the computer system such that the instructions that effectuate the virtual processors will be backed by logical processors. Thus, in these example embodiments, multiple virtual processors can be simultaneously executing while, for example, another logical processor is executing hypervisor instructions. Generally speaking, and as illustrated by the figures, the combination of virtual processors, various VSCs, and memory in a partition can be considered a virtual machine such as virtual machine 240 or 242.

Generally, guest operating systems 220 through 222 can include any operating system such as, for example, operating systems from Microsoft®, Apple®, the open source community, etc. The guest operating systems can include user/kernel modes of operation and can have kernels that can include schedulers, memory managers, etc. A kernel mode can include an execution mode in a logical processor that grants access to at least privileged processor instructions. Each guest operating system 220 through 222 can have associated file systems that can have applications stored thereon such as terminal servers, e-commerce servers, email servers, etc., and the guest operating systems themselves. The guest operating systems 220-222 can schedule threads to execute on the virtual processors 230-232 and instances of such applications can be effectuated.

Referring now to FIG. 3, illustrated is an alternative architecture that can be used to effectuate virtual machines. FIG. 3 depicts similar components to those of FIG. 2, however in this example embodiment the hypervisor 202 can include the virtualization service providers 228 and device drivers 224, and parent partition 204 may contain configuration utilities 236. In this architecture, hypervisor 202 can perform the same or similar functions as the hypervisor 202 of FIG. 2. The hypervisor 202 of FIG. 3 can be a stand alone software product, a part of an operating system, embedded within firmware of the motherboard or a portion of hypervisor 202 can be effectuated by specialized integrated circuits. In this example parent partition 204 may have instructions that can be used to configure hypervisor 202 however hardware access requests may be handled by hypervisor 202 instead of being passed to parent partition 204.

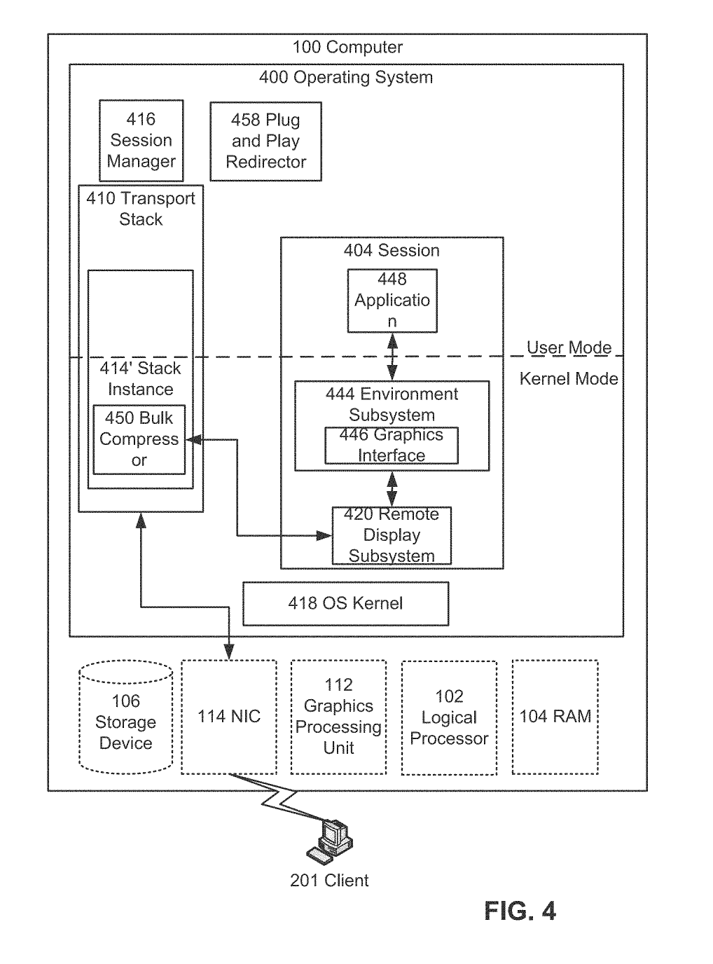

Referring now to FIG. 4, computer 100 may include circuitry configured to provide remote desktop services to connecting clients. In an example embodiment, the depicted operating system 400 may execute directly on the hardware or a guest operating system 220 or 222 may be effectuated by a virtual machine such as VM 216 or VM 218. The underlying hardware 208, 210, 234, 212, and 214 is indicated in the illustrated type of dashed lines to identify that the hardware can be virtualized.

Remote services can be provided to at least one client such as client 401 (while one client is depicted remote services can be provided to more clients.) The example client 401 can include a computer terminal that is effectuated by hardware configured to direct user input to a remote server session and display user interface information generated by the session. In another embodiment, client 401 can be effectuated by a computer that includes similar elements as those of computer 100 FIG. 1b. In this embodiment, client 401 can include circuitry configured to effect operating systems and circuitry configured to emulate the functionality of terminals, e.g., a remote desktop client application that can be executed by one or more logical processors 102. One skilled in the art can appreciate that the circuitry configured to effectuate the operating system can also include circuitry configured to emulate a terminal.

Each connecting client can have a session (such as session 404) which allows the client to access data and applications stored on computer 100. Generally, applications and certain operating system components can be loaded into a region of memory assigned to a session. Thus, in certain instances some OS components can be spawned N times (where N represents the number of current sessions). These various OS components can request services from the operating system kernel 418 which can, for example, manage memory; facilitate disk reads/writes; and configure threads from each session to execute on the logical processor 102. Some example subsystems that can be loaded into session space can include the subsystems that generates desktop environments, the subsystems that track mouse movement within the desktop, the subsystems that translate mouse clicks on icons into commands that effectuate an instance of a program, etc. The processes that effectuate these services, e.g., tracking mouse movement, are tagged with an identifier associated with the session and are loaded into a region of memory that is allocated to the session.

A session can be generated by a session manager 416, e.g., a process. For example, the session manager 416 can initialize and manage each remote session by generating a session identifier for a session space; assigning memory to the session space; and generating system environment variables and instances of subsystem processes in memory assigned to the session space. The session manager 416 can be invoked when a request for a remote desktop session is received by the operating system 400.

A connection request can first be handled by a transport stack 410, e.g., a remote desktop protocol (RDP) stack. The transport stack 410 instructions can configure logical processor 102 to listen for connection messages on a certain port and forward them to the session manager 416. When sessions are generated the transport stack 410 can instantiate a remote desktop protocol stack instance for each session. Stack instance 414 is an example stack instance that can be generated for session 404. Generally, each remote desktop protocol stack instance can be configured to route output to an associated client and route client input to an environment subsystem 444 for the appropriate remote session.

As shown by the figure[?], in an embodiment an application 448 (while one is shown others can also execute) can execute and generate an array of bits. The array can be processed by a graphics interface 446 which in turn can render bitmaps, e.g., arrays of pixel values, that can be stored in memory. As shown by the figure, a remote display subsystem 420 can be instantiated which can capture rendering calls and send the calls over the network to client 401 via the stack instance 414 for the session.

In addition to remoting graphics and audio, a plug and play redirector 458 can also be instantiated in order to remote diverse devices such as printers, mp3 players, client file systems, CD ROM drives, etc. The plug and play redirector 458 can receive information from a client side component which identifies the peripheral devices coupled to the client 401. The plug and play redirector 458 can then configure the operating system 400 to load redirecting device drivers for the peripheral devices of the client 401. The redirecting device drivers can receive calls from the operating system 400 to access the peripherals and send the calls over the network to the client 401.

As discussed above, clients may use a protocol for providing remote presentation services such as Remote Desktop Protocol (RDP) to connect to a resource using terminal services. When a remote desktop client connects to a terminal server via a terminal server gateway, the gateway may open a socket connection with the terminal server and redirect client traffic on the remote presentation port or a port dedicated to remote access services. The gateway may also perform certain gateway specific exchanges with the client using a terminal server gateway protocol transmitted over HTTPS.

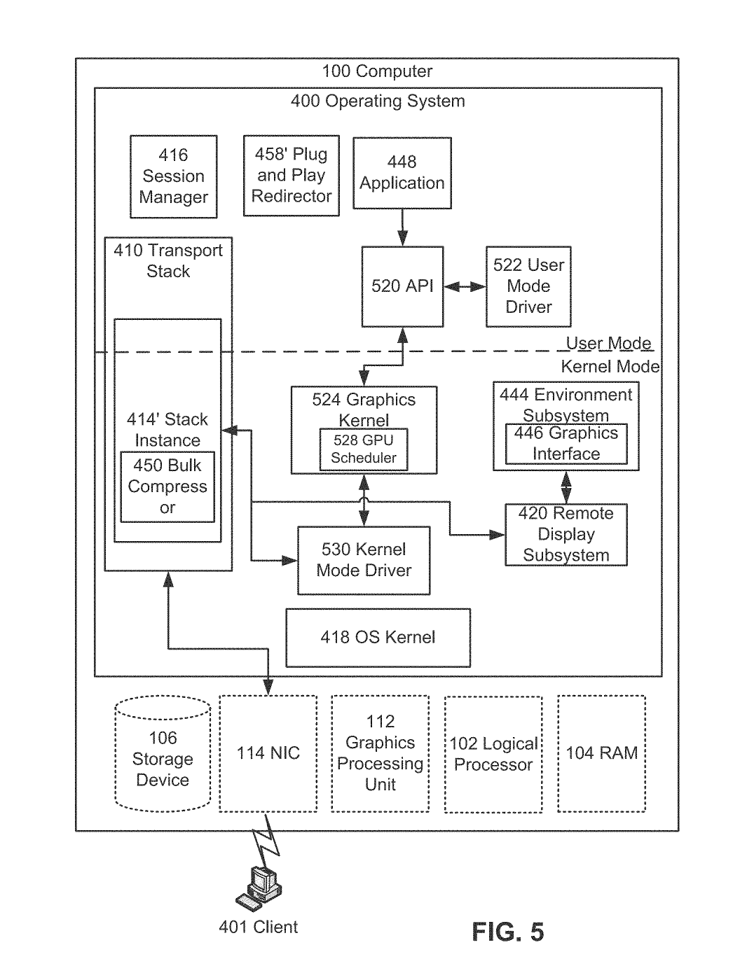

Turning to FIG. 5, depicted is a computer system 100 including circuitry for effectuating remote services and for incorporating aspects of the present disclosure. As shown by the figure, in an embodiment a computer system 100 can include components similar to those described in FIG. 1b and FIG. 4, and can effectuate a remote presentation session. In an embodiment of the present disclosure a remote presentation session can include aspects of a console session, e.g., a session spawned for a user using the computer system, and a remote session. Similar to that described above, the session manager 416 can initialize and manage the remote presentation session by enabling/disabling components in order to effectuate a remote presentation session.

One set of components that can be loaded in a remote presentation session are the console components that enable high fidelity remoting, namely, the components that take advantage of 3D graphics and 2D graphics rendered by 3D hardware.

3D/2D graphics rendered by 3D hardware can be accessed using a driver model that includes a user mode driver 522, an API 520, a graphics kernel 524, and a kernel mode driver 530. An application 448 (or any other process such as a user interface that generates 3D graphics) can generate API constructs and send them to an application programming interface 520 (API) such as Direct3D from Microsoft®. The API 520 in turn can communicate with a user mode driver 522. The user mode driver can copy primitives generated by applications. Primitives are the fundamental geometric shapes used in computer graphics represented as vertices and constants which are used as building blocks for other shapes. The primitives may be stored in buffers, e.g., pages of memory. The user mode driver may copy the primitives into buffers along with commands on how to draw a given shape using the primitives. In one embodiment the application 448 can declare how it is going to use the buffer, e.g., what type of data it is going to store in the buffer. An application, such as a videogame, may use a dynamic buffer to store primitives for an avatar and a static buffer for storing data that will not change often such as data that represents a building or a forest.

In addition to graphics primitives, texture (pixel) data (used when drawing a triangle, for example) may also be sent from the child partition to the host partition. Additionally, it may sometimes be necessary to transfer pixels from the host partition back to the child partition. This may happen, for example, when an application draws into a surface using the GPU and then makes a request to examine the pixels in the surface. Since the surface was updated on the host partition but the application is running on the child partition, the updated surface data may need to be transferred back to the child partition to make the data accessible to the application.

Continuing with the description of the driver model, the application can fill the buffers with primitives and issue execute commands. When the application issues an execute command the buffer can be appended to a run list by the kernel mode driver 530 and scheduled by the graphics kernel scheduler 528. Each graphics source, e.g., application or user interface, can have a context and its own run list. The graphics kernel 524 can be configured to schedule various contexts to execute on the graphics processing unit 112. The GPU scheduler 528 can be executed by logical processor 102 and the scheduler 528 can issue a command to the kernel mode driver 530 to render the contents of the buffer. The stack instance 414 can be configured to receive the command and send the contents of the buffer over the network to the client 401 where the buffer can be processed by the GPU of the client.

Illustrated now is an example of the operation of a virtualized GPU as used in conjunction with an application that calls for remote presentation services. Referring to FIG. 5, in an embodiment a virtual machine session can be generated by a computer 100. For example, a session manager 416 can be executed by a logical processor 102 and a remote session that includes certain remote components can be initialized. In this example the spawned session can include a kernel 418, a graphics kernel 524, a user mode display driver 522, and a kernel mode display driver 530. The user mode driver 522 can generate graphics primitives that can be stored in memory. For example, the API 520 can include interfaces that can be exposed to processes such as a user interface for the operating system 400 or an application 448. The process can send high level API commands such as such as Point Lists, Line Lists, Line Strips, Triangle Lists, Triangle Strips, or Triangle Fans, to the API 420. The API 520 can receive these commands and translate them into commands for the user mode driver 522 which can then generate vertices and store them in one or more buffers. The GPU scheduler 528 can run and determine to render the contents of the buffer. In this example the command to the graphics processing unit 112 of the server can be captured and the content of the buffer (primitives) can be sent to client 401 via network interface card 114. In an embodiment, an API can be exposed by the session manager 416 that components can interface with in order to determine whether a virtual GPU is available.

In an embodiment a virtual machine such as virtual machine 240 of FIG. 2 or 3 can be instantiated and the virtual machine can serve as a platform for execution for the operating system 400. Guest operating system 220 can embody operating system 400 in this example. A virtual machine may be instantiated when a connection request is received over the network. For example, the parent partition 204 may include an instance of the transport stack 410 and may be configured to receive connection requests. The parent partition 204 may initialize a virtual machine in response to a connection request along with a guest operating system including the capabilities to effectuate remote sessions. The connection request can then be passed to the transport stack 410 of the guest operating system 220. In this example each remote session may be instantiated on an operating system that is executed by its own virtual machine.

In one embodiment a virtual machine can be instantiated and a guest operating system 220 embodying operating system 400 can be executed. Similar to that described above, a virtual machine may be instantiated when a connection request is received over the network. Remote sessions may be generated by an operating system. The session manager 416 can be configured to determine that the request is for a session that supports 3D graphics rendering and the session manager 416 can load a console session. In addition to loading the console session the session manager 416 can load a stack instance 414′ for the session and configure system to capture primitives generated by a user mode display driver 522.

The user mode driver 522 may generate graphics primitives that can be captured and stored in buffers accessible to the transport stack 410. A kernel mode driver 530 can append the buffers to a run list for the application and a GPU scheduler 528 can run and determine when to issue render commands for the buffers. When the scheduler 528 issues a render command the command can be captured by, for example, the kernel mode driver 530 and sent to the client 401 via the stack instance 414′.

The GPU scheduler 528 may execute and determine to issue an instruction to render the content of the buffer. In this example the graphics primitives associated with the instruction to render can be sent to client 401 via network interface card 114.

In an embodiment, at least one kernel mode process can be executed by at least one logical processor 112 and the at least one logical processor 112 can synchronize rendering vertices stored in different buffers. For example, a graphics processing scheduler 528, which can operate similarly to an operating system scheduler, can schedule GPU operations. The GPU scheduler 528 can merge separate buffers of vertices into the correct execution order such that the graphics processing unit of the client 401 executes the commands in an order that allows them to be rendered correctly.

One or more threads of a process such as a videogame may map multiple buffers and each thread may issue a draw command. Identification information for the vertices, e.g., information generated per buffer, per vertex, or per batch of vertices in a buffer, can be sent to the GPU scheduler 528. The information may be stored in a table along with identification information associated with vertices from the same, or other processes and used to synchronize rendering of the various buffers.

An application such as a word processing program may execute and declare, for example, two buffers—one for storing vertices for generating 3D menus and the other one storing commands for generating letters that will populate the menus. The application may map the buffer and issue draw commands. The GPU scheduler 528 may determine the order for executing the two buffers such that the menus are rendered along with the letters in a way that it would be pleasing to look at. For example, other processes may issue draw commands at the same or a substantially similar time and if the vertices were not synchronized vertices from different threads of different processes could be rendered asynchronously on the client 401 thereby making the final image displayed seem chaotic or jumbled.

A bulk compressor 450 can be used to compress the graphics primitives prior to sending the stream of data to the client 401. In an embodiment the bulk compressor 450 can be a user mode (not shown) or kernel mode component of the stack instance 414 and can be configured to look for similar patterns within the stream of data that is being sent to the client 401. In this embodiment, since the bulk compressor 450 receives a stream of vertices, instead of receiving multiple API constructs, from multiple applications, the bulk compressor 450 has a larger data set of vertices to sift through in order to find opportunities to compress. That is, since the vertices for a plurality of processes are being remoted, instead of diverse API calls, there is a larger chance that the bulk compressor 450 will be able to find similar patterns in a given stream.

In an embodiment, the graphics processing unit 112 may be configured to use virtual addressing instead of physical addresses for memory. Thus, the pages of memory used as buffers can be paged to system RAM or to disk from video memory. The stack instance 414′ can be configured to obtain the virtual addresses of the buffers and send the contents from the virtual addresses when a render command from the graphics kernel 528 is captured.

An operating system 400 may be configured, e.g., various subsystems and drivers can be loaded to capture primitives and send them to a remote computer such as client 401. Similar to that described above, a session manager 416 can be executed by a logical processor 102 and a session that includes certain remote components can be initialized. In this example the spawned session can include a kernel 418, a graphics kernel 524, a user mode display driver 522, and a kernel mode display driver 530.

A graphics kernel may schedule GPU operations. The GPU scheduler 528 can merge separate buffers of vertices into the correct execution order such that the graphics processing unit of the client 401 executes the commands in an order that allows them to be rendered correctly.

All of these variations for implementing the above mentioned partitions are just exemplary implementations, and nothing herein should be interpreted as limiting the disclosure to any particular virtualization aspect.

### Virtualization of Graphics Accelerators

The process of compressing, encoding and decoding graphics data as referring to herein may generally use one or more methods and systems described in commonly assigned U.S. Pat. No. 7,460,725 entitled “System And Method For Effectively Encoding And Decoding Electronic Information,” hereby incorporated by reference in its entirety.

A graphics processing unit or GPU is a specialized processor that offloads 3D graphics rendering from the microprocessor. A GPU may provide efficient processing of mathematical operations commonly used in graphics rendering by implementing various graphics primitive operations. A GPU may provide faster graphics processing as compared to the host CPU. A GPU may also be referred to as a graphic accelerators.

GPU capabilities have continuously grown in recent years, from drawing rectangles or bitmaps to rasterizing and transforming triangles. Functions such as transformation and shading are now programmable whereas previously such functions were fixed in hardware.

Graphics applications may use Application Programming Interfaces (APIs) to configure the graphics processing pipeline and provide shader programs which perform application specific vertex and pixel processing on the GPU. Many graphics applications interact with the GPU using an API such as Microsoft's DirectX or the OpenGL standard.

As described above, virtualization multiplexes physical hardware by presenting each virtual machine with a virtual device and combining their respective operations in the hypervisor or virtual machine monitor such that hardware resources are used while maintaining the perception that each virtual machine has a complete standalone hardware resource. Graphics accelerators present unique challenges because of their complexity. Unlike CPUs, GPU specification information may be difficult to obtain and GPU architectures may change dramatically across short generational cycles. Thus, it is difficult to provide a virtual device corresponding to a GPU.

Even if a complete virtual implementation can be provided, the cost of updating the implementation for each GPU generation may be cost prohibitive. While the virtualization of CPUs has become increasingly popular in part because the hardware state and context can be readily saved, the virtualization of GPUs is difficult because of the complexity of each virtual machine's graphics activity. A CPU can be time sliced by time slicing the CPU contexts. However, the context of a GPU runs deep as the operations are highly pipelined and the switching of contexts in real-time from one virtual machine to another is typically very difficult and expensive. While multiple copies of all the GPU registers may be maintained, this is impractical even if the hardware can be scaled or more registers and memory can be added. In these solutions, the processing power of the GPU may not be fully harnessed. Another method of virtualizing the GPU may be to completely virtualize the GPU in software, but satisfactory real time performance may not be realizable.

As discussed, a virtual machine monitor (VMM) or hypervisor is a software system that may partition a single physical machine into multiple virtual machines. Earlier VMMs created a precise replica of the underlying physical machine, and in many cases primarily catered to server side scenarios such as server consolidation. Generally, server workloads such as file servers or web servers do not require sophisticated presentation technologies such as 3D graphics. Hence the graphics virtualization technologies in earlier VMMs were limited to 2D graphics. Many enterprise applications are now emerging in which consolidation of end user desktops using virtualization is desirable. This new type of workload called desktop consolidation (for example VDI—virtual desktop infrastructure) requires the ability to present 3D graphics within a virtual machine. Since VMMs typically virtualize only a 2D graphic device, there is a need to virtualize a 3D graphic device.

A VDI solution that incorporates 3D graphics capability may enable the end users to run 2D and 3D graphical applications in a virtual machine and enable IT administrators to share physical graphics devices across multiple users in a vendor agnostic fashion. In an embodiment, a virtualized graphics device may be provided that exposes a virtual 2D and 3D graphics device to a virtual machine. By using such a virtualized graphics device, end users may run 3D applications such as Windows Aero in a virtual machine.

In one embodiment of a virtualized GPU, the virtualization boundary may be established at a relatively high level in the stack and the graphics driver may be executed in the host or hypervisor. By using this approach, the virtualization details do not rely on specific GPU specifications. Access to the GPU may be provided through the vendor provided APIs and drivers on the host while the virtual machine need only interact with software.

In some cases, graphics API calls may be forwarded without modifications from the guest to the external graphics stack using remote procedure calls. In other cases, a virtual GPU may be emulated and host graphics operations may be simulated in response to requests by the guest device drivers. A balanced approach may be used to address the disadvantages of allowing multiple entry points and developing a complicated interface.

In another embodiment, the graphics driver stack may be executed inside the virtual machine with the virtualization boundary between the stack and the physical GPU hardware. Some advantages in performance and fidelity may be achieved but the ability to multiplex may be limited. Since the virtual machine will interact directly with proprietary hardware, the execution state is bound to the specific GPU hardware.

In an embodiment, a software only proxy device may be added in the guest operating system that is backed by an actual physical 3D graphics device on the host operating system. The proxy device exposes a set of 3D GPU capabilities to the guest operating system. In one exemplary embodiment, a virtual GPU mechanism may be provided that includes a virtual GPU Windows Display Driver Model (WDDM) driver on the guest and a rendering component on the host. WDDM is a graphic driver architecture for video card drivers running MICROSOFT WINDOWS and provides rendering functionality for desktop applications using Desktop Window Manager. The rendering component may be part of a render/capture/compress subsystem.

A virtual machine may render into a virtual device via the virtual GPU device driver. The actual rendering may be accomplished by accelerating the rendering using a single or multiple GPU controllers in another virtual machine (the parent virtual machine) or on a remote machine (that acts as a graphics server) that is shared by many guest virtual machines. An image capture component on the parent virtual machine may retrieve snapshots of the desktop images. The captured images can be optionally compressed and encoded prior to transmitting to the client. The compression and encoding can take place on the parent virtual machine or the child or guest virtual machine. A remote presentation protocol such as Remote Desktop Protocol (RDP) may be used to connect to the virtual machines from remote clients and for transmitting the desktop images. In this manner, a remote user can experience graphical user interfaces such as Windows Aero and execute 3D applications and multimedia via a remote login.

The virtualization scheme may based on one or both of two modes. In one embodiment, a user mode driver may provide for a virtualization boundary higher in the graphics stack, and a kernel mode driver may provide a virtualization boundary lower in the graphics stack. In one embodiment, the virtual GPU subsystem may comprise a display driver that further comprises user mode and kernel mode components that execute on the virtual machines, and the render component of the render/capture/compress process that executes on the parent partition. In an embodiment, the display driver may be a Windows Display Driver Model (WDDM) driver.

Driver calls on the virtual machine may be translated to API calls on the host or parent partition. For example, one set of APIs may be the Microsoft DirectX set of APIs for handling tasks related to multimedia, in particular Direct3D which is the 3D graphics API within DirectX. By providing such a virtualization infrastructure, the concurrent use of a single physical GPU by multiple virtual machines may be enabled and the virtual machines may be exposed to 3D and multimedia capabilities. Multiple virtual machines may then accelerate 3D rendering tasks on a single or multiple GPUs in the host machine.

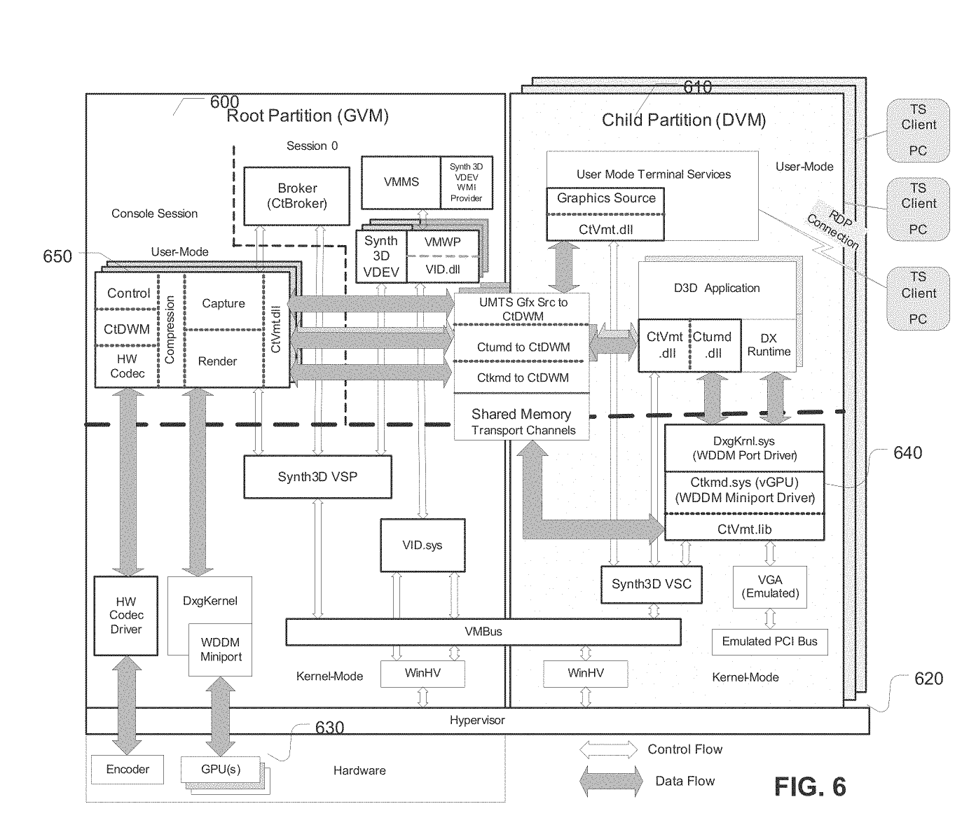

FIG. 6 illustrates an exemplary embodiment of a virtual machine scenario for implement a virtual GPU as a component in a VDI scenario. In this example, the VDI may provide 3D graphics capability for each child virtual machine 610 instantiated by the hypervisor 620 on a server platform. Each child virtual machine 610 may load a virtual GPU driver 640. The system may be populated with GPU accelerator(s) 630 which are accessible from the parent or root partition 600. The physical GPUs 630 on the parent or root partition 600 (also known as a GVM—Graphics Virtual Machine) may be shared by the different child virtual machines 610 to perform graphics rendering operations.

The virtual GPU subsystem may virtualize the physical GPU and provide accelerated rendering capability for the virtual machines. The virtual GPU driver may, in one embodiment, be a WDDM driver 640. The driver may remote corresponding commands and data to the parent partition for rendering. A rendering process, which may be part of a render/capture/compress subsystem 650, may perform the corresponding rendering on the GPU. For each virtual machine, there may be provided a corresponding render/capture/compress component 650 on the host or parent partition 600. WDDM drivers allow video memory to be virtualized, with video data being paged out of video memory into system RAM.

On request by a graphics source sub-system running on the child virtual machine, the render/capture/compress subsystem 650 may return compressed or uncompressed screen updates as appropriate. The screen updates may be based on the changed rectangle size and the content. The virtual GPU driver may support common operating systems such as VIST and WINDOWS 7.

As discussed, some embodiments may incorporate a WDDM driver. A WDDM driver acts as if the GPU is a device configured to draw pixels in video memory based on commands stored in a direct memory access (DMA) buffer. DMA buffer information may be sent to the GPU which asynchronously processes the data in order of submission. As each buffer completes, the run-time is notified and another buffer is submitted. Through execution of this processing loop, video images may be processed and ultimately rendered on the user screens. Those skilled in the art will recognize that the disclosed subject matter may be implemented in systems that use OpenGL and other products.

DMA buffer scheduling may be driven by a GPU scheduler component in the kernel mode. The GPU scheduler may determine which DMA buffers are sent to the GPU and in what order.

The user mode driver may be configured to convert graphic commands issued by the 3D run-time API into hardware specific commands and store the commands in a command buffer. This command buffer may then be submitted to the run-time which in turn calls the kernel mode driver. The kernel mode driver may then construct a DMA buffer based on the contents of the command buffer. When it is time for a DMA buffer to be processed, the GPU scheduler may call the kernel mode driver which handles all of the specifics of actually submitting the buffer to the GPU hardware.

The kernel mode driver may interface with the physical hardware of the display device. The user-mode driver comprises hardware specific knowledge and can build hardware specific command buffers. However, the user-mode driver does not directly interface with the hardware and may rely on the kernel mode driver for that task. The kernel mode driver may program the display hardware and cause the display hardware to execute commands in the DMA buffer.

In one embodiment, all interactions with the host or parent partition may be handled through the kernel mode driver. The kernel mode driver may send DMA buffer information to the GVM and make the necessary callbacks into the kernel-mode API run-time when the DMA buffer has been processed. When the run-time creates a graphics device context, the run-time may call a function for creating a graphics device context that holds a rendering state collection. In one embodiment, a single kernel-mode connection to the GVM may be created when the first virtual graphics device is created. Subsequent graphics devices may be created with coordination from the user mode device and the connection to the GVM for those devices may be handled by the user mode device.

In another embodiment, a connection to the host or parent partition may be established each time the kernel-mode driver creates a new device. A connection context may be created and stored in a per-device data structure. This connection context may generally consist of a socket and I/O buffers. Since all communication with the GVM goes through the kernel-mode driver, this per device connection context may help ensure that commands are routed to the correct device on the host or parent partition.

In one embodiment, a separate thread may be provided on the host or parent partition for each running instance of the user mode device. This thread may be created when an application creates a virtual device on the child partition. An additional rendering thread may be provided to handle commands that originate from the kernel mode on the child partition (e.g., kernel mode presentations and mouse pointer activity).

In one embodiment, the number of rendering threads on the GVM may be kept at a minimum to match the number of CPU cores.

Additional tasks may be performed when managing a GPU. For example, in addition to providing graphics primitives, the hardware context for the GPU may be maintained. Pixel shaders, vertex shaders, clipping planes, scissor rectangles and other settings that affect the graphics pipeline may be configured. The user mode driver may also determine the logical values for these settings and how the values translate into physical settings.

In one embodiment, the user mode driver may be responsible for constructing hardware contexts and command buffers. The kernel mode driver may be configured to convert command buffers into DMA buffers and provide the information to the GPU when scheduled by the GPU scheduler.

The virtual GPU may be implemented across several user mode and kernel mode components. In one embodiment, a virtual machine transport (VMT) may be used as a protocol to send and receive requests across all the components. The VMT may provide communication between modules that span two or more partitions. Since there are multiple components in each partition that communicate across the partitions, a common transport may be defined between the components.

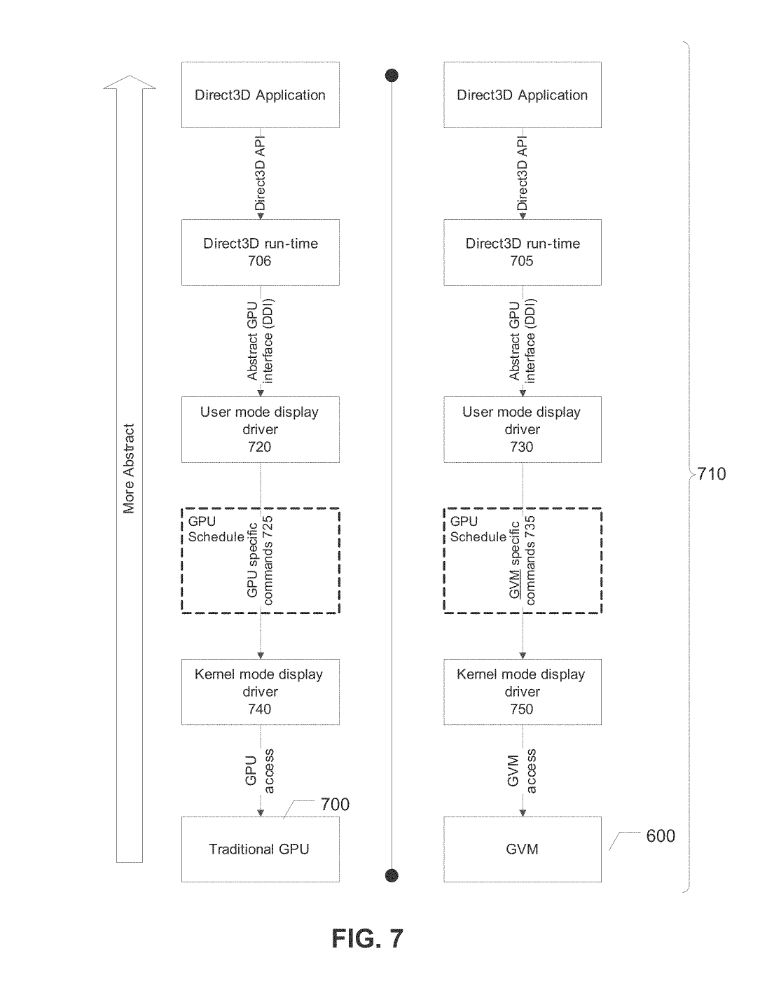

FIG. 7 depicts the layers of abstraction in a traditional driver and those in one exemplary embodiment of a virtual GPU driver. Like a traditional GPU 700, the GVM 600 (the root partition) can be viewed as being situated at the bottom of the driver stack 710. The GVM 600 represents the graphics hardware and abstracts the interfaces of a traditional GPU 700 as if the GPU were present in the virtual machine. The virtual GPU driver thus provides access to the GVM within the constraints of the driver model.

The display driver 740 may receive GPU specific commands 725 and may be written to be hardware specific and control the GPU 700 through a hardware interface. The display driver 740 may program I/O ports, access memory mapped registers, and otherwise interact with the low level operation of the GPU device. The virtual GPU driver 750 may receive GVM specific commands 735 and may be written to a specific interface exposed by the GVM 600. In one embodiment, the GVM may be a Direct3D application running on a different machine, and the GVM may act as a GPU that natively executes Direct3D commands. In this embodiment, the commands that the user mode display driver 730 receives from the Direct3D run-time 705 can be sent to the GVM 600 unmodified.

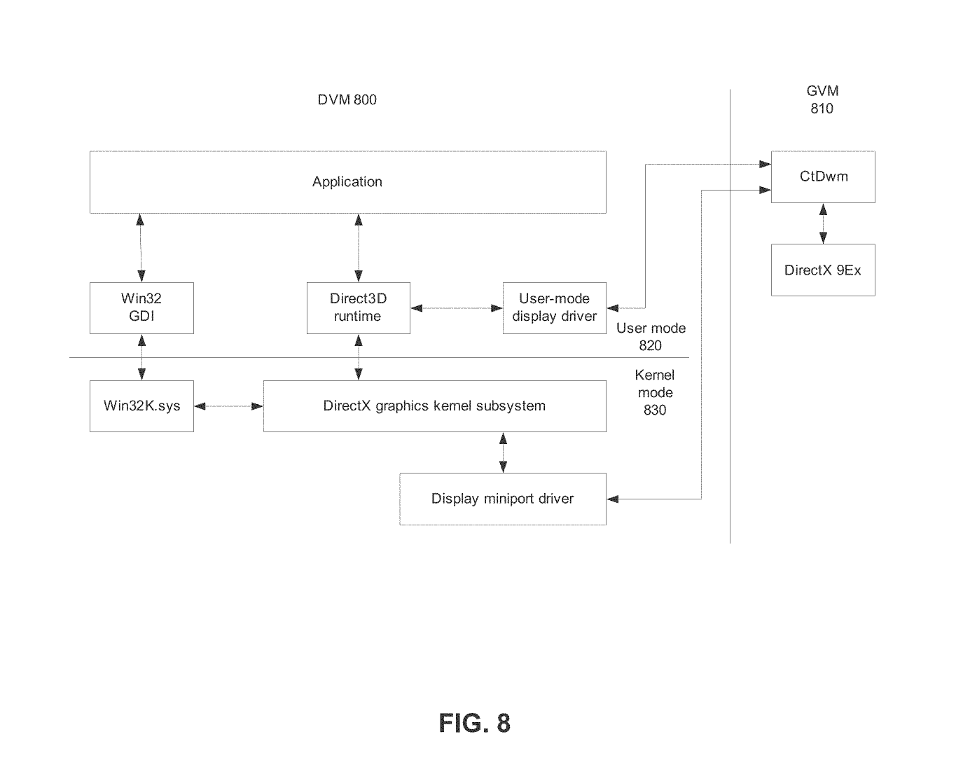

As shown in FIG. 8, in one embodiment, the Direct3D commands on the child partition (DVM) 800 may be encoded in the user mode driver 820 and the kernel mode driver 830 and sent along with the data parameters to the GVM 810. On the GVM 810, a component may render the graphics by using the hardware GPU.

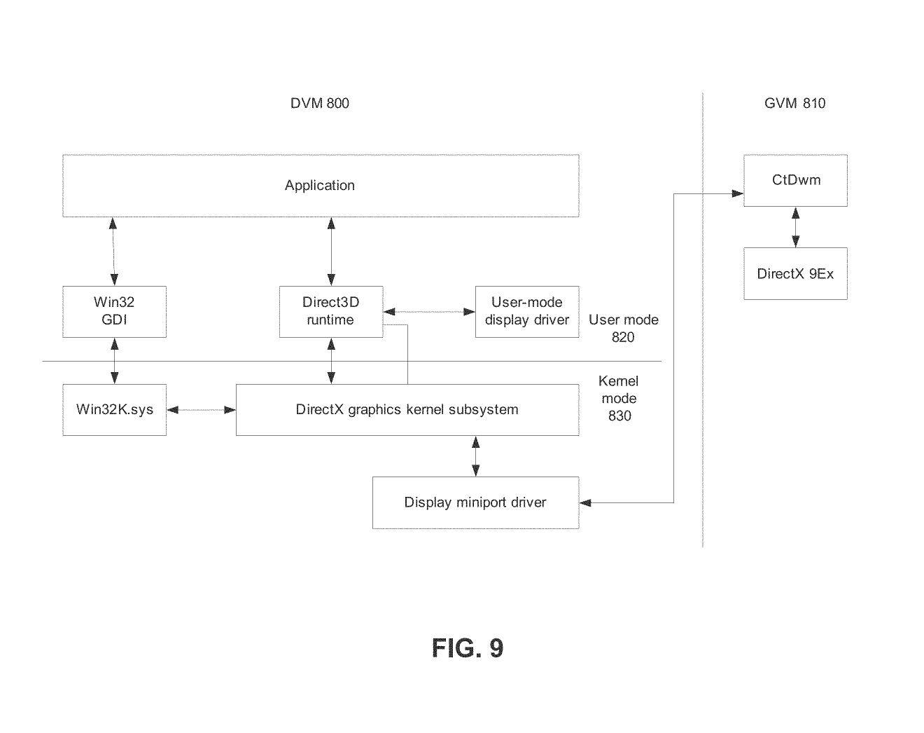

In another embodiment depicted in FIG. 9, the Direct3D commands on the child partition (DVM) 800 may be sent to the user mode driver 820 and the kernel mode driver 830. The commands may be interpreted/adapted in the kernel mode driver 830 and placed in DMA buffers in the kernel mode. The GVM 810 may provide virtual GPU functionality, and command buffers may be constructed by the user mode driver 820. The command buffer information may be sent to the kernel mode driver 830 where they may be converted into DMA buffers and submitted to the GVM 810 for execution. On the GVM, a component may render the commands on the hardware GPU.

When an application requests execution of a graphics processing function, the corresponding command and video data may be made available to a command interpreter function. For example, a hardware independent pixel shader program may be converted into a hardware specific program. The translated command and video data may be placed in the GVM work queue. This queue may then be processed and the pending DMA buffers may be sent to the GVM for execution. When the GVM receives the commands and data, the GVM may use a Direct3D API to convert the commands/data into a form that is specific to the GVM's graphics hardware.

Thus, in the child partition a GPU driver may be provided that conceptually looks to each virtual machine as a real graphics driver but in reality causes the routing of the virtual machine commands to the parent partition. On the parent partition the image may be rendered using the real GPU hardware.

In one embodiment, a synthetic 3D video device may be exposed to the virtual machine and the virtual machine may search for drivers that match the video device. A virtual graphics display driver may be provided that matches the device, which can be found and loaded by the virtual machine. Once loaded, the virtual machine may determine that it can perform 3-D tasks and expose the device capabilities to the operating system which may use the functions of the virtualized device.

The commands received by the virtual machine may call the virtual device driver interface. A translation mechanism may translate the device driver commands to DirectX commands. The virtual machine thus believes it has access to a real GPU that calls the DDI and device driver. The device driver calls coming in are received and translated, the data is received, and on the parent side the DDI commands may be re-created back into the DirectX API to render what was supposed to be rendered on the virtual machine. In some instances, converting DDI commands into DirectX API commands may be inefficient. In other embodiments, the DirectX API may be circumvented and the DDI commands may be converted directly into DDI commands on the host partition. In this embodiment, the DirectX subsystem may be configured to allow for this circumvention.

In another embodiment, only one connection may be established to the GVM and communication with the graphics device contexts can be multiplexed over one communication channel. While there is typically a one to one mapping of graphics devices from the DVM to the GVM, in this embodiment the communication channel is not associated with any particular graphics device. A “select device” token may be sent before sending commands that are destined for a particular device. The “select device” token indicates that all subsequent commands should be routed to a particular graphics device. A subsequent “select device” token may be sent when graphics commands should to be sent to a different device.

Alternatively, in another embodiment only one graphics device may available on the GVM. Here, a many-to-one mapping of devices from the DVM to devices on the GVM may be implemented. The correct GPU state may be sent before sending commands associated with a particular graphics device. In this scenario, the GPU state is maintained by the DVM instead of the GVM. In this embodiment the illusion that multiple graphics device contexts exist on the DVM is created, but in reality all are processed by one graphics device context on the GVM that receives the correct GPU state before processing commands associated with a given DVM graphics device context.

Thus in various embodiments, a GPU may be abstracted and device driver calls on a virtual machine may be sent to a parent or host partition (GVM) where the commands are translated to use the API of the graphics server. Before sending to the parent partition, the device driver calls may be converted into intermediate commands and data before they are sent to the parent partition and converted to the application level API. The intermediate stages may be implementation specific and depend on the particular hardware being used.

Using the above described techniques, a stable virtual GPU can be synthesized and a given virtual machine need not be concerned with the particular piece of hardware that sits underneath as long as the minimum requirements are met by the underlying device. For example, in one situation the GVM may by using an NVIDIA GPU and in another case the GVM may be using an ATI device. In either case, a virtual set of capabilities may be exposed as long as the underlying GPU provides a minimal predetermined set of capabilities. The application running on the virtual machine operates as though the WDDM driver has a stable set of features. The virtual machine may be saved and migrated to another system using a different GPU without affecting the application using the GPU services.

As shown in FIG. 6, illustrated is an embodiment in which a WDDM driver and an application are communicating with the DX driver via the OS. The driver passes data through the VM bus which in one embodiment is a shared memory transport. The data may be sent to the render/capture/compress component on the parent partition. On the parent partition the image/video may be rendered on the actual GPU hardware. As described in U.S. Pat. No. 7,460,725, a render/capture/compress component may capture images based on what has changed since a previous captured frame and then optionally compress the changed areas using the GPU and/or CPU resources. The compressed data may then be passed back through the shared memory bus to the graphics plug-in on the virtual machine, and ultimately the user mode stack that provides the remote monitoring capability to the end user.

In some embodiments, multiple GPUs may be provided on the parent partition. The rendering tasks for a plurality of virtual machines may be distributed for processing on the multiple GPUs. The multiple GPUs may be abstracted to appear as one GPU. Alternatively, a single GPU can be abstracted into multiple GPUs. In one embodiment, a system may expose capabilities that are abstracted and that an actual GPU does not specifically provide. These capabilities can be emulated by, for example, synthesizing the functions in software. It can be seen that in a traditional setting a virtual machine that is migrated must have available an identical piece of GPU hardware and thus the migration may be dependent on the specific features of a particular GPU. However, using the virtual GPU techniques described herein, a stable set of capabilities can be abstracted and a virtual machine that migrates may not need to be concerned about the underlying hardware.

In some embodiments multiple hosts may be provided. For example, a first virtual machine may be associated with a real piece of GPU hardware and additional virtual machines may be configured to communicate with the first virtual machine to provide virtual GPU capabilities. In some cases, the virtual machine that directly interfaces to the hardware GPU can be on the parent partition with the virtual machines using the virtual GPU on the other side. Alternatively, a child virtual machine may be assigned ownership of the GPU hardware.

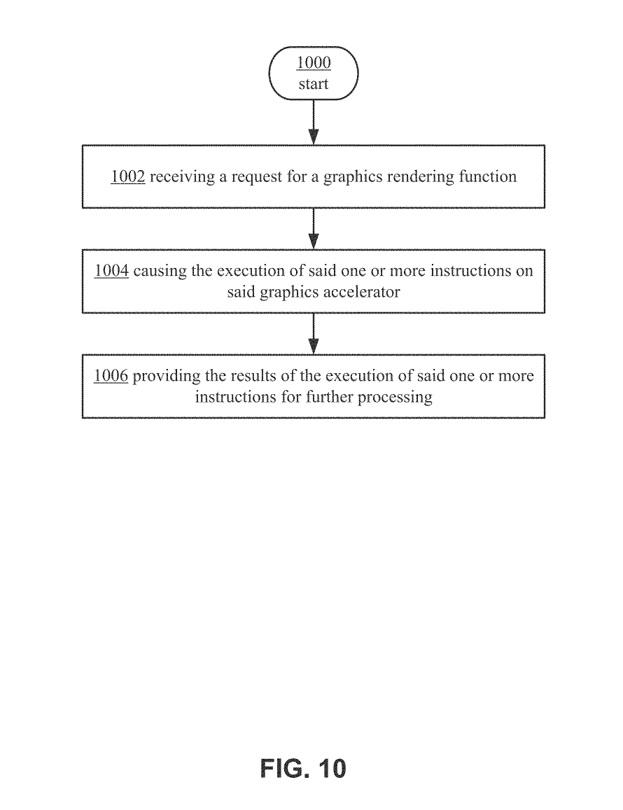

FIG. 10 depicts an exemplary operational procedure for providing virtualized graphics accelerator functionality to a virtual machine including operations 1000, 1002, 1004, and 1006. Referring to FIG. 10, operation 1000 begins the operational procedure and operation 1002 illustrates receiving, from an application executing on said virtual machine, a request for a graphics rendering function. In one embodiment, the request may correspond to at least one operation associated with a virtual graphics processing unit configured to provide a set of graphics rendering functions, wherein the at least one operation corresponds to one or more instructions executable on an underlying graphics processing unit. Operation 1004 illustrates causing the execution of said one or more instructions on said underlying graphics processing unit tiles. Operation 1006 illustrates providing the results of the execution of said one or more instructions for further processing.

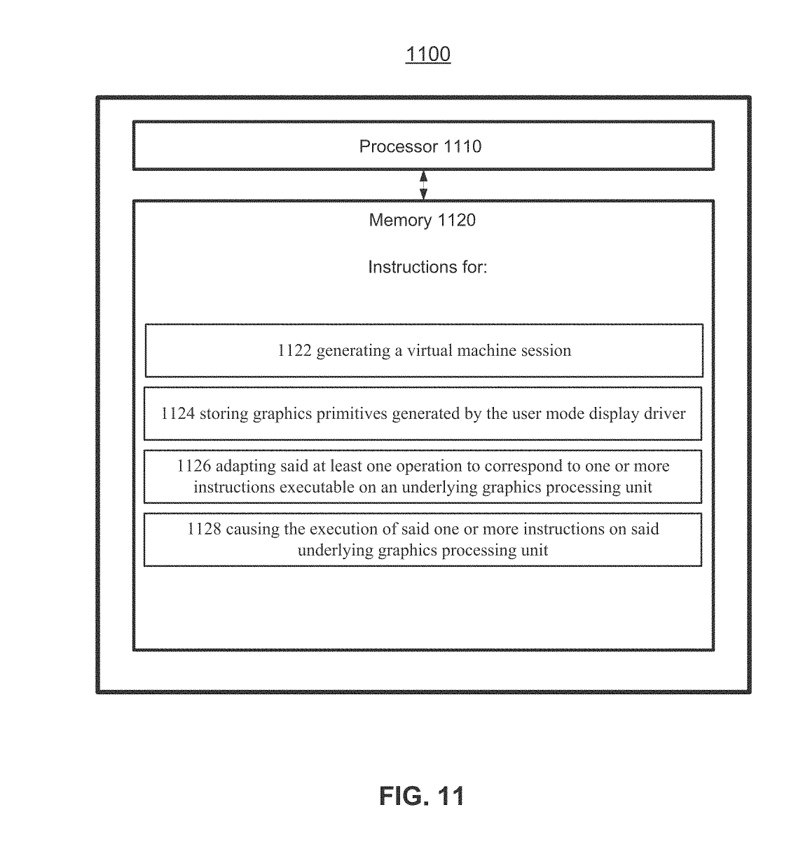

FIG. 11 depicts an exemplary system for providing virtualized graphics accelerator functionality to a virtual machine as described above. Referring to FIG. 11, system 1100 comprises a process 1110 and memory 1120. Memory 1120 further comprises computer instructions configured to provide virtualized graphics accelerator functionality to a virtual machine. Block 1122 illustrates generating a virtual machine session, the virtual machine session including a graphics kernel and a user mode display driver. Block 1124 illustrates storing graphics primitives generated by the user mode display driver. In one embodiment, the graphics primitives may corresponding to at least one operation associated with a virtual graphics processing unit configured to provide a set of graphics rendering functions. Block 1126 illustrates adapting said at least one operation to correspond to one or more instructions executable on an underlying graphics processing unit. Block 1128 illustrates causing the execution of said one or more instructions on said underlying graphics processing unit.

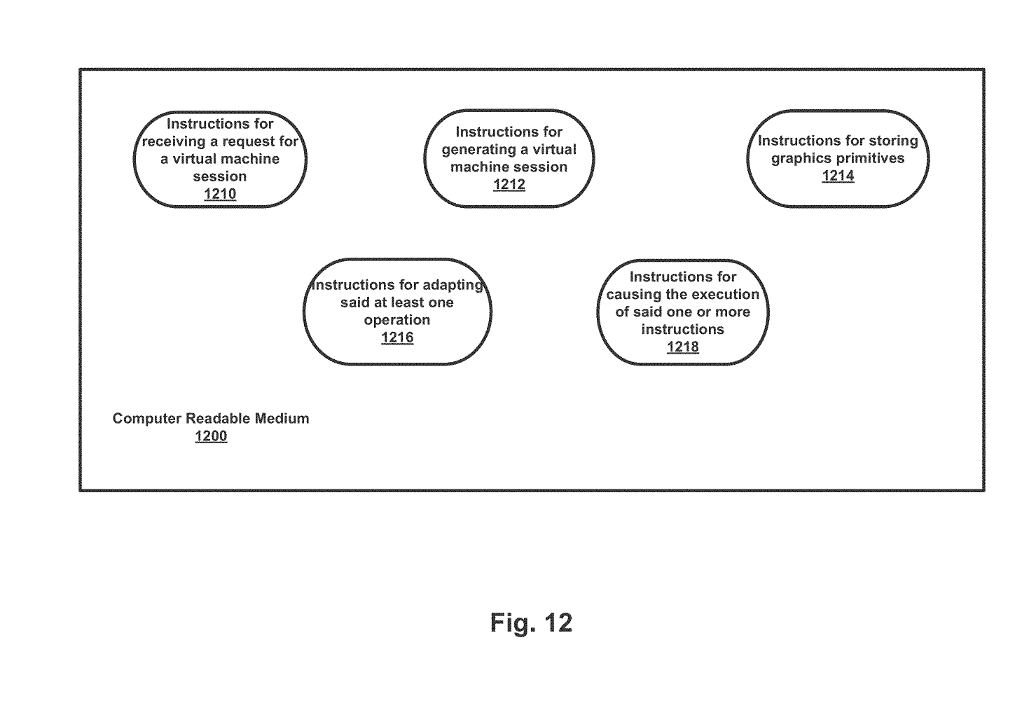

Any of the above mentioned aspects can be implemented in methods, systems, computer readable media, or any type of manufacture. For example, per FIG. 12, a computer readable medium can store thereon computer executable instructions for providing virtualized graphics accelerator functionality to a virtual machine. Such media can comprise a first subset of instructions for receiving a request for a virtual machine session 2910; a second subset of instructions for generating a virtual machine session, the virtual machine session including an operating system kernel, a graphics kernel, a user mode display driver, and a kernel mode display driver 2912; a third subset of instructions for storing graphics primitives generated by the user mode display driver, said graphics primitives corresponding to at least one operation associated with a virtual graphics processing unit configured to provide a set of graphics rendering functions 2914; a fourth set of instructions for adapting said at least one operation to correspond to one or more instructions executable on an underlying graphics processing unit 2916; and a fifth set of instructions for causing the execution of said one or more instructions on said underlying graphics processing unit 2918. It will be appreciated by those skilled in the art that additional sets of instructions can be used to capture the various other aspects disclosed herein, and that the three presently disclosed subsets of instructions can vary in detail per the present disclosure.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

It should be understood that the various techniques described herein may be implemented in connection with hardware or software or, where appropriate, with a combination of both. Thus, the methods and apparatus of the disclosure, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the invention has been particularly shown and described with reference to a preferred embodiment thereof, it will be understood by those skilled in the art that various changes in form and detail may be made without departing from the scope of the present invention as set forth in the following claims. Furthermore, although elements of the invention may be described or claimed in the singular, the plural is contemplated unless limitation to the singular is explicitly stated.

1. (canceled)

2. A method for providing graphics functionality to a first partition of a system comprising a processor, memory, and a graphics accelerator device, the method comprising:
loading, in the first partition, a software interface comprising graphics capabilities that are abstracted from capabilities of the graphics accelerator device;
loading, in a second partition, a graphics capturing and rendering process;
receiving, by the software interface on the first partition, a request to render graphics, wherein the request is based on the abstracted graphics capabilities;
rendering, by the graphics capturing and rendering process, the requested graphics on the second partition, wherein the abstracted graphics capabilities are effectuated in accordance with the capabilities of the graphics accelerator device; and
providing, by the capturing process executing on the second partition, the rendered graphics to the first partition.

3. The method of claim 2, further comprising receiving, by the second partition, a snapshot of a desktop associated with the first partition.

4. The method of claim 2, further comprising generating, by the capturing and rendering process, a screen update to the first partition.

5. The method of claim 3, further comprising:
receiving, by the second partition, a snapshot of a desktop associated with the first partition; and
generating, by the capturing and rendering process, a screen update to the first partition, wherein the screen update is based at least in part on the snapshot.

6. The method of claim 2, further comprising capturing, by the capturing and rendering process, a graphics primitive rendered on the second partition.

7. The method of claim 2, further comprising loading, in the second partition, additional capturing and rendering processes corresponding to additional partitions.

8. The method of claim 2, wherein the software interface comprises a software-implemented GPU.

9. A system for providing graphics functionality to a first partition, the system comprising a graphics accelerator device, at least one processor, and at least one memory communicatively coupled to said at least one processor, the memory having stored therein computer-executable instructions that, when executed by the at least one processor, cause the system to perform operations comprising:
loading, in the first partition, a software interface comprising graphics capabilities that are abstracted from capabilities of the graphics accelerator device;
loading, in a second partition, a capturing and rendering process;
receiving, by the software interface on the first partition, a request to render graphics, wherein the request is based on the abstracted graphics capabilities;
rendering, by the graphics capturing and rendering process, the requested graphics on the second partition, wherein the abstracted graphics capabilities are effectuated in accordance with the capabilities of the graphics accelerator device; and
providing, by the capturing and rendering process executing on the second partition, the rendered graphics to the first partition.

10. The system of claim 9, further comprising computer-executable instructions that, when executed by the at least one processor, cause the system to perform operations comprising receiving, by the second partition, a snapshot of a desktop associated with the first partition.

11. The system of claim 9, further comprising computer-executable instructions that, when executed by the at least one processor, cause the system to perform operations comprising generating, by the capturing and rendering process, a screen update to the first partition.

12. The system of claim 9, further comprising computer-executable instructions that, when executed by the at least one processor, cause the system to perform operations comprising capturing, by the capturing and rendering process, a graphics primitive rendered on the second partition.

13. The system of claim 9, further comprising computer-executable instructions that, when executed by the at least one processor, cause the system to perform operations comprising loading, in the second partition, additional capturing and rendering processes corresponding to additional partitions.

14. The system of claim 9, wherein the software interface comprises a software-implemented GPU.

15. The system of claim 9, further comprising computer-executable instructions that, when executed by the at least one processor, cause the system to perform operations comprising:
receiving, by the second partition, a snapshot of a desktop associated with the first partition; and
generating a screen update to the first partition, wherein the screen update is based at least in part on the snapshot.

16. A computer-readable storage medium storing thereon computer executable instructions that, when executed by at least one processor of a computing device, cause the computing device to perform the following operations:
loading, in a first partition, a software interface comprising graphics capabilities that are abstracted from capabilities of a graphics accelerator device of the computing device;
loading, in a second partition, a capturing and rendering process;
receiving, by the software interface on the first partition, a request to render graphics, wherein the request is based on the abstracted graphics capabilities;
rendering, by the graphics capturing and rendering process, the requested graphics, wherein the abstracted graphics capabilities are translated to the capabilities of the graphics accelerator device; and
providing, by the capturing and rendering process executing on the second partition, the rendered graphics to the first partition.

17. The computer-readable storage medium of claim 16, further comprising computer-executable instructions that, when executed by the at least one processor, cause the computing device to perform operations comprising receiving, by the second partition, a snapshot of a desktop associated with the first partition.

18. The computer-readable storage medium of claim 16, further comprising computer-executable instructions that, when executed by the at least one processor, cause the computing device to perform operations comprising generating, by the capturing and rendering process, a screen update to the first partition.

19. The computer-readable storage medium of claim 16, further comprising computer-executable instructions that, when executed by the at least one processor, cause the computing device to perform operations comprising capturing, by the capturing and rendering process, a graphics primitive rendered on the second partition.

20. The computer-readable storage medium of claim 16, further comprising computer-executable instructions that, when executed by the at least one processor, cause the computing device to perform operations comprising loading, in the second partition, additional capturing and rendering processes corresponding to additional partitions.

21. The computer-readable storage medium of claim 16, wherein the software interface comprises a software-implemented GPU.
